(19) United States
(12) Patent Application Publication
(10) Pub. No.: US 2009/0327224 A1
(43) Pub. Date: Dec. 31, 2009

(54) Automatic Classification of Search Engine Quality

(75) Inventors: Ryen William White, Kirkland, WA (US); Mikhail Bilenko, Bellevue, WA (US); Matthew R. Richardson, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,813

(22) Filed: Jun. 26, 2008

(51) Int. Cl. G06F 17/30

(52) U.S. Cl. 707/3; 707/E17.108

(57) ABSTRACT

Aspects of the subject matter described herein relate to predicting a best search engine to use for a given query. In aspects, a predictor may use various approaches to determine a best search engine for a given query. For example, the predictor may use features derived from the query itself, how well the query matches a result set returned by a search engine in response to the query, and/or information that compares the result sets returned by multiple search engines that are provided the query. In addition, other data such as user preferences, user interaction data, metadata attributes, and/or other data may be used in predicting a best search engine for a given query. In conjunction with making a prediction, the predictor may use a classifier that has been trained at a training facility.

### BACKGROUND

Web search engines provide users with rapid access to much of the Web's content. Although users occasionally use other engines, they are typically loyal to a single search engine, even when it may not satisfy their needs. A user may be loyal to a single search engine despite the fact that the cost of switching engines is relatively low. While most users may be happy with their experience on their engine of choice, there may be other reasons why users do not select another search engine when they have not been able to find desired information. For example, a user may not want the inconvenience or the burden of adapting to a new engine, be unaware of how to change the default settings in their Web browser to point to a particular engine, or be unaware of other Web search engines that provide better service. Since different search engines perform well compared to other engines for some queries and poorly for others, excessive search engine loyalty may actually hinder users' ability to search effectively.

Commercial meta-search engines help people utilize the collective power of multiple search engines. A meta-search engine queries multiple search engines, receives results from the search engines, combines the results, and sends the combined results to the user who requested the search. The meta-search engine approach to searching for information, however, has short-comings compared to encouraging users to proactively switch search engines. For example, when combining results, the meta-search engine may obliterate the benefits of interface features and global-page optimizations including search result diversity of the individual engines.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to predicting a best search engine to use for a given query. In aspects, a predictor may use various approaches to determine a best search engine for a given query. For example, the predictor may use features derived from the query itself, how well the query matches a result set returned by a search engine in response to the query, and/or information that compares the result sets returned by multiple search engines that are provided the query. In addition, other data such as user preferences, user interaction data, metadata attributes, and/or other data may be used in predicting a best search engine for a given query. In conjunction with making a prediction, the predictor may use a classifier that has been trained at a training facility.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a diagram that generally represents finding a route using constraints according to aspects of the subject matter described herein;

FIG. 2 is a block diagram that generally represents components and data that may be used and generated at a training facility in accordance with aspects of the subject matter described herein;

FIG. 3 is a block diagram illustrating an apparatus configured to predict a best search engine to service a query in accordance with aspects of the subject matter described herein; and

FIGS. 4-6 are flow diagrams that generally represent actions that may occur in predicting a best search engine in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise.

### Automatic Classification of Search Engine Quality

As mentioned previously, search engine loyalty may actually hinder users' ability to search effectively. In accordance with aspects of the subject matter described herein, a mechanism is described that predicts the best-performing search engine for a given query. A user may use any search engine the user desires and have an alternative engine suggested when, for example, it is predicted that another engine performs better for the user's current query, or when the user seems dissatisfied with the current set of search results, or when it can be inferred (or the user explicitly indicates) that the user desires topic coverage, result set recency, or other similar distinguishing features in the result set.

The mechanism encourages a user to leverage multiple search engines, switching to the most effective engine for a given query. In one embodiment, the mechanism is instantiated as a categorical classifier and trained on features of the query and the result pages from different engines that include the titles/snippets/URLs of the top-ranked documents. Other possible training features include the click-through rate on each of the engines, the overlap between result sets offered by the different engines, temporal information on the pages in the result sets (e.g., creation date), Web link information between pages, and the like for different queries.

Search engine performance for a given search query may be predicted from a number of features derived from such sources including user interaction (e.g., the proportion of times that a query is issued and a result clicked, the average rank position of a click for that query), estimated relevance (e.g., a relevance score assigned to a set of search results derived from a human judgment process), diversity statistics (e.g., the amount of overlap/correlation/divergence between result sets), metadata attributes (e.g., the recency of the pages in the result set), other sources, and the like. The component that estimates search engine performance may determine the relative quality of multiple result sets instead of the quality of any individual result set.

Relevance may be defined algorithmically in search engines as the strength of topical association between the query and each document in the retrieved set. Search results are normally presented in descending order of estimated relevance.

Result set diversity relative to a current search engine may be calculated by determining whether another search engine returns results that cover aspects of the query topic(s) that are not covered by the current search engine for the current query. Determining relative result set diversity may include, for example, studying differences in the URLs or contents (e.g., through term distributions and information-theoretic techniques) from the top results returned by each of the engines under comparison.

Result set recency indicates whether another search engine returns results that are more timely than the current engine for the current query. Result set recency may be determined through automatic inspection of the creation/edit time of search results, accessible through Hypertext Transfer Protocol (HTTP) header information for result pages, or other automatic means such as querying a service (e.g., provided by a third party or by the search engine itself) for page recency, or by extracting the information from the result page if provided by the search engine.

Given interaction logs from a search engine, it is possible to estimate the relevance of the search results served by an engine for a particular query by the proportion of query instances that lead to a click on a search result (i.e., the click-through rate) or the rank position of a search result click (i.e., highly-ranked search result clicks are indicative of highly-relevant search results). However, if the interaction logs are not available, an alternative approach may be used. One exemplary alternative approach may be based solely on features of the top-ranked search results from each engine (or even the current search engine alone). These features are readily available.

### Switching Classifier

Comparison of search result sets from different search engines may be modeled in several ways. One approach is to predict the quality of the results for each engine independently and subsequently compare their scores. An alternative approach is to consider the different engines simultaneously, where the single objective of the predictor is to correctly determine whether one engine produces results of better or equal quality than the other engines. Since the underlying problem facing the user is a decision task based on the pair of result sets, this “coupled” approach is a more appropriate abstraction. Thus, an objective is learning to make classification decisions whether it is beneficial to switch to a particular alternate search engine E′ from the current engine E.

Modeling the difference in quality between sets of search results can be viewed as a regression task (predicting the real-valued difference in quality between the result sets), or as a classification task (where the prediction is an output of whether switching to a particular engine is worthwhile, without directly learning to quantify the expected difference in result quality). To model the switching decision task, classification may be a more suitable choice, since it most closely mirrors the switching decision task. The actual utility of switching for a given user depends on such factors as the relative costs of interruption and benefits of obtaining better and/or different search results, and can be incorporated into the classification task via the concept of a margin in quality between the result sets (by assigning “positive” labels to sets of results sets where the difference in quality is above the minimum margin corresponding to switching utility).

Formally, let a given problem instance consist of a query q and two search engine result pages, R from the current search engine, and R′ for an alternative search engine. This setting could be trivially expanded to more than two search engine result pages, however the following discussions uses two engines for clarity. Let a given query q have a human-judged result set R*={(d₁,s₁), . . . , (dₖ,sₖ)} consisting of k ordered URL-judgment pairs, where each judgment reflects how well the URL satisfies the information need expressed in the query, perhaps on a scale from 0 (Bad) to 5 (Perfect). Then, performance of each search engine for the query can be computed via their Normalized Discounted Cumulative Gain (NDCG) scores based on the returned results sets: U(R)=NDCG_{R}·(R) and U(R′)=NDCG_{R}·(R′). DCG is a measure of relevance. “Discounted” means that URLs further down the list have less influence on the measure. “Cumulative” means that it is a measure over the top N results, not just one result. “Gain” means that larger is better. DCG may be normalized (e.g., NDCG), where the N means “normalized”, meaning that for a given query, the DCG is divided by the max DCG possible for that query. The NDCG therefore takes values in the range [0,1]. Performance can also be measured using other metrics, including, for example, MAP (mean average precision), other metrics, and the like.

Suppose that the user benefits from switching support if the alternative search engine provides results which have utility that differs by at least ε≧0. Then, a dataset of such queries Q={(q,R,R′,R*)} yields a set of corresponding instances and labels, D={(x,y)}, where every instance x=f(q,R₁,R₂) is comprised of features derived from the query and result pages as described in the next section, and the corresponding binary label y encodes whether destination engine performance differs from origin engine performance by at least ε: y=IsTrue(NDCG_{R}·(R′)≧NDCG_{R}·(R)+ε). Although NDCG is optimized in this instantiation of the classifier, it is possible to optimize for any reasonable measure of retrieval performance (e.g., precision, recall, other performance measures, and the like). If M(R) is the metric measured on set R (and M(R′) for R′), it can be said that y=IsTrue (M_{R}·(R′)≧M_{R}·(R)+ε.

In accordance with aspects of the subject matter described herein, virtually any classifier may be trained for the task of determining whether another search engine returns better results. However, for most real-time applications, low computational and memory costs may be given more weight in selecting an appropriate algorithm. When a search is executed in a browser, the switching support framework may execute the same search on alternative engines in the background, subsequently computing features for the classifier, which may then predict whether alternative engines are to be suggested.

Furthermore, users' interaction with the switching support system may provide additional training information for the classifier. To support this type of training, a classifier may be created, where learning is performed using a continuously incoming stream of instances with labels derived from user interaction (e.g., using such indicators of user satisfaction as click-through on the search results page or dwell time on result pages). In one embodiment, a maximum-margin averaged perceptron may be employed as the classifier. It will be recognized, however, that the perceptron classifier, however, is only an example of a classifier that is possible to use in this setting. Other suitable classifiers may range in complexity and degree of automation from a machine-learning technique such as that described herein to a set of hand-written rules.

A classifier predicts whether or not the user would benefit from obtaining search results for the current query from the other engine(s). In one embodiment, this prediction is provided in real-time. The prediction is based only on features derived from the query and the different sets of results (those of the current search engine, and those of the alternative search engine(s)) to assure efficiency.

Features may be separated into at least three broad categories: (i) features derived from the result pages, (ii) features based on the query, and (iii) features based on the matching between the query and the results page. The subsequent sections describe each of these feature sets in more detail, while Table 1 provides an exemplary list of features. These features are only examples of the type of features that may be used. Additional features including the nature of query suggestions, instant answers, or search advertising may also be used. Additionally, features may be based on other data, such as the graph structure of the result set and the Web pages “near” the result set, domain registration information, IP addresses, Web community structure, and the like. In an intranet environment in which searches are conducted from an enterprise network, for example, additional features derived about authors and their position in the enterprise may also be employed. On the desktop, features of the user and the user's long-term interests and preferences may also be used. Features of the result set may be used to train classifiers that automate the comparison of search result sets.

Each engine's result page contains a ranked list of search results, where each result may be described by a title, a snippet (a short summary), and its URL. The results page features capture the following properties of each result:

1. Textual statistics for the title, URL, and the snippet, such as the number of characters, number of tokens, number of times ellipses (i.e., “ . . . ”) appear, other textual statistics, and the like.

2. Properties of the URL. Some exemplary properties of the URL include its type (e.g., whether it is a “.com”, “.net”, or some other type), what type of extension a page has (e.g., .html, .aspx, and so forth), the number of directories in the URL path, the presence of special characters, other properties, and the like.

Furthermore, there are features of the results page that are not captured by the result lists themselves. For example, search engines often inform the user how many total pages in their index contain the given query terms (e.g., “Results 1-10 of 64,500”). The total pages number is also a feature. Other features encode such results page properties as whether spelling correction was engaged, features of any query-alteration suggestions, and features based on any advertisements also found on the page.

Query Features. Different search engines may have ranking algorithms that perform particularly well (or particularly poorly) on certain classes of queries. For example, one engine may focus on answering rare (“long-tail”) queries, while another may focus on common queries. Thus, features can also be derived from query properties, such as the length of the query, the presence of stop-words (common terms like “the”, “and”, other common terms, and the like), named entities, and so forth.

Match Features. A set of features may capture how well the result page matches the query. For example, match features may encode how often query words appear in the title, snippets, or result URLs, how often the entire query, bigrams, tri-grams, or some other sequence of the query appear in these segments, and the like. Since search engines attempt to create a snippet that represents the most relevant piece of a document, snippets that contain many words of the query often indicate a relevant result, while few or no words of the query likely correspond to a less relevant result.

Higher-Order Features. Non-linear transforms of each feature may also be provided to the classifier, so it can directly utilize the most appropriate feature representation. Some exemplary non-linear transforms include the logarithm and the square of each feature value although other non-linear transforms may also be used without departing from the spirit or scope of aspects of the subject matter described herein. A group of meta-features may be based on combinations of feature values for the two engines. For example, a binary feature may be used that indicates whether the number of results that contain the query is at least 50% greater in the alternative engine than in the current engine. Simple differences between features (e.g., the number of results on the alternative engine minus the number on the current engine) may be represented by giving a higher positive weight to the first component of the difference, and a lower negative weight to the second.

Below is Table 1 which indicates some exemplary features that may be employed in classification.

TABLE 1
Exemplary features employed in classification

Results Page Features
10 binary features indicating whether there are 1-10 results
Number of results
For each title and snippet:
# of characters
# of words
# of HTML tags
# of “. . .” (indicate skipped text in snippet)
# of “.” (indicates sentence boundary in snippet)
# of characters in URL
# of characters in domain (e.g., “apple com”)
# of characters in URL path (e.g., “download/quicktime.html”)
# of characters in URL parameters (e.g., “?uid=45&p=2”)
3 binary features: URL starts with “http”, “ftp”, or “https”
5 binary features: URL ends with “html”, “aspx”, “php”, “htm”
9 binary features: .com, .net, .org, .edu, .gov, .info, .tv, .biz, or .uk
# of “/” in URL path (i.e., depth of the path)
# of “&” in URL path (i.e., number of parameters)
# of “=” in URL path (i.e., number of parameters)
# of matching documents (e.g., “results 1-10 of 2375”)
Query Features
# of characters in query
# of words in query
# of stop words (a, an, the, . . . )
8 binary features: Is i^{th} query token a stopword
8 features: word lengths (# chars) ordered from smallest to largest
8 features: word lengths ordered from largest to smallest
Average word length
Match Features
For each text type (title, snippet, URL):
# of results where the text contains the exact query
3 features: # of top-1, top-2, top-3 results containing query
# of query bigrams contained in the results
# of bigrams in the top-1, top-2, top-3 results
# of domains containing the query in the top-1, top-2, top-3

### Improving Classifier Performance

In addition to what has been described above, other things may be done to improve classifier performance. Some examples of improving performance include using the current engine as a filter, using behavioral data, and incorporating user preferences as described in more detail below.

Use current engine features or use current engine as a filter. Features of multiple search engines' results may be used in their comparison (as has been described herein), or, if there is a need to restrict network traffic or search engine load, results from a single (e.g., the current) search engine may be used, with a small reduction in predictive accuracy. In one approach, a single-engine classifier may be used to filter out the queries that are least likely to be served better by the alternate engine(s). The queries that pass this initial test may then be evaluated using the classifier based on features from multiple engines, to increase overall precision.

Use user interaction data to improve classifier performance. User preferences mined from user interaction data may improve classifier performance. Following the release of an application containing a classifier, logs of user interaction with the application may be mined and evidence of user satisfaction or dissatisfaction may be extracted from the logs. User feedback may be captured explicitly (e.g., after an engine switch a message appears asking the user if the switch was useful), or implicitly (e.g., post-switch interactions may be studied to see if users click on a search result on the destination engine or return to the origin engine). This evidence may be used to (i) to improve the performance of future versions of the classifier by providing feedback to designers about when the classifier performs well, and/or (ii) to improve the performance of the classifier on the fly, by dynamically updating feature values and retraining the classifier periodically on the client-side.

Incorporate user preferences. Users of an application that includes a classifier may also set options about their favorite engine and specific features to use that are important to them in the decision to switch engines. These options may include identifying/assigning weights to features important to a user or allowing users to identify features based on their perceived value in differentiating engines. Additional preference information may also be inferred automatically from usage data about how often users employ a particular search engine and their average result click through rates on each engine they use (as a measure of search success). In addition to benefiting the individual user, the pooled option settings from multiple users may be periodically uploaded to a central server, aggregated, and used in weighting features in future versions of the classifier, based on their apparent importance to many users.

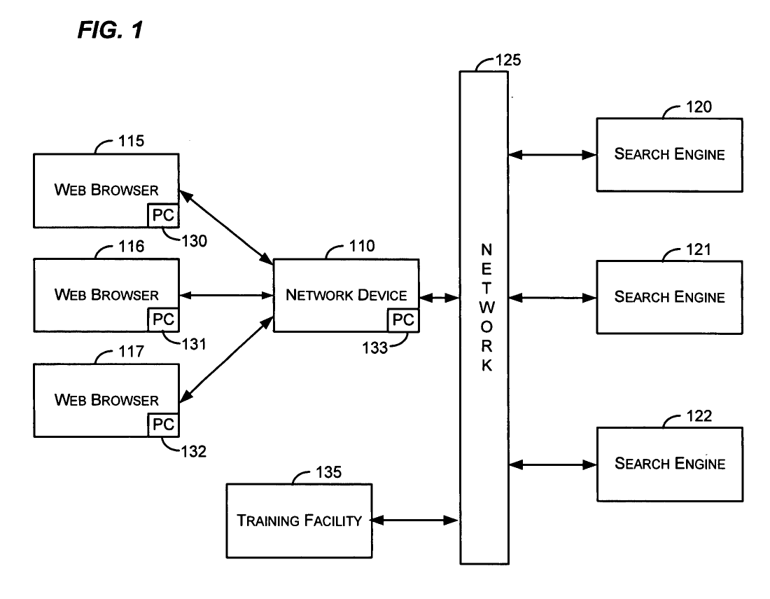

FIG. 1 is a block diagram representing an exemplary environment in which aspects of the subject matter described herein may be implemented. Aspects of the subject matter described herein are operational with numerous general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like. The term “computer” as used herein may include any one or more of the devices mentioned above or any similar devices.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Computer-readable media as described herein may be any available media that can be accessed by a computer and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Turning to FIG. 1, the environment includes a network device 110, Web browsers 115-117, search engines 120-122, a network 125, a training facility 135, and may include other entities (not shown). The various entities may communicate with each other via various networks including intra- and inter-office networks and the network 125. In an embodiment, the network 125 may comprise the Internet. In an embodiment, the network 125 may comprise one or more private networks, virtual private networks, or the like. The Web browsers 115-117, the devices hosting the Web browsers 115-117, and/or the network device 110 may include predicting components 130-133, respectively.

Each of the Web browsers 115-117, the search engines 120-122, and the training facility 135 may be hosted on one or more computers. The Web browsers 115-117 may submit queries to and receive results from any of the search engines 120-122. Communications to and from the Web browsers may pass through the network device 110.

The training facility 135 may comprise one or more computers that may train classifiers used by the predicting components 130-133. The training facility 135 may use information that is gathered automatically, semi-automatically, or manually in training classifiers.

The network device 110 may comprise a general purpose computer configured to pass network traffic or a special purpose computer (e.g., a firewall, router, bridge, or the like). The network device 110 may receive packets to and from the Web browsers 115-117.

The predicting components 130-133 may include logic and data that predict which search engine is best for satisfying a particular query. This logic and data may comprise the logic and data described previously. A predicting component may monitor user interaction with search engines and may use this information in predicting a best search engine. A predicting component may also provide this information to the training facility 135 for use in training classifiers that are used by the predicting components 130-133.

In one embodiment, the predicting component 133 on the network device 110 is optional. When the predicting component 133 is present, the predicting components 130-132 may be omitted as the predicting component 133 may monitor user interactions, predict best search engines for queries, and use this information as appropriate to encourage a user to switch to a different search engine as indicated previously.

In one embodiment, one or more additional entities (not shown) may be connected to the network 125 to perform the function of predicting a best search engine. These entities may host Web services, for example, that may be called by a process (e.g., one of the Web browsers 115-117) that is seeking to predict the best search engine for a particular query. The calling process may pass the query together with any other additional information to an entity and may receive a prediction of a best search engine in response.

Although the environment described above includes a network device, web browsers, search engines, and a training facility in various configurations, it will be recognized that more, fewer, and/or a different combination of these and other entities may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

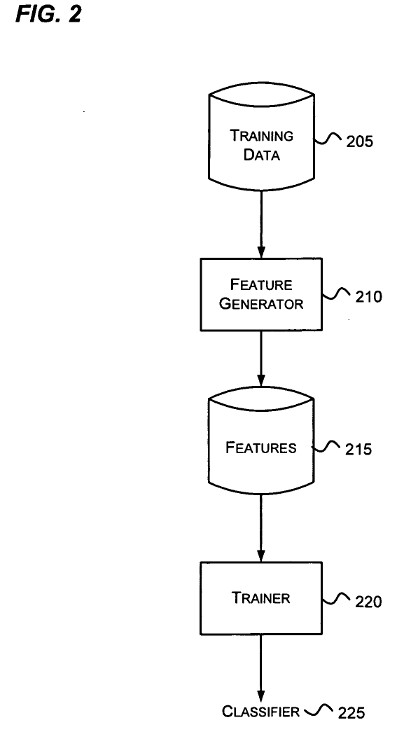

FIG. 2 is a block diagram that generally represents components and data that may be used and generated at a training facility in accordance with aspects of the subject matter described herein. The training data 205 may include, for example, tuples that associate queries with search engines. Each tuple may include a query and a search engine that has been labeled as best for the query. A tuple may also include data from a result returned when submitting the query to a search engine. A tuple may also include other information (e.g., user interaction data and the other information previously described) that may be used in training.

The training data 205 is input into a feature generator 210 that extracts/derives features 215 from the training data 205. The features may include any of the features described herein.

The features 215 and labels are input into a trainer 220 that creates a classifier 225. The classifier 225 may include data, rules, or other information that may be used during run time to predict a best search engine for a given query. The classifier 225 may comprise one classifier or a set of classifiers that work together to predict a best search engine. Based on the teachings herein, those skilled in the art may recognize other mechanisms for creating a classifier that may also be used without departing from the spirit or scope of aspects of the subject matter described herein.

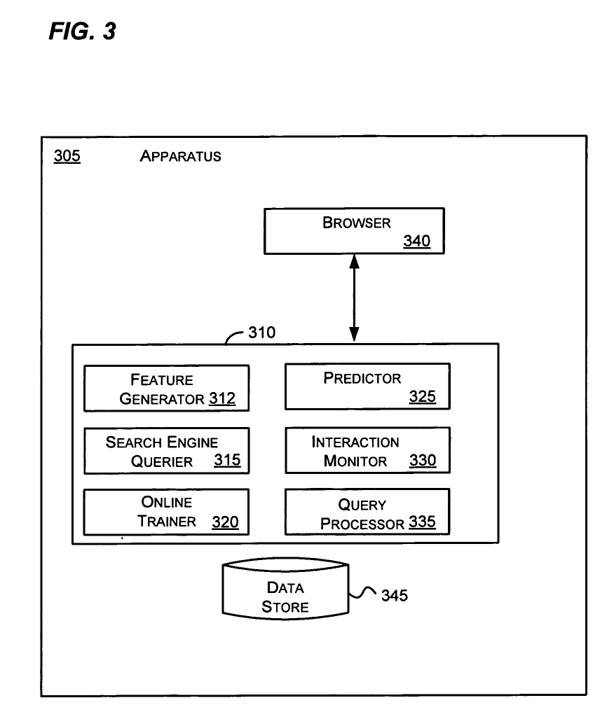

FIG. 3 is a block diagram illustrating an apparatus configured to predict a best search engine to service a query in accordance with aspects of the subject matter described herein. The components illustrated in FIG. 3 are exemplary and are not meant to be all-inclusive of components that may be needed or included. In other embodiments, the components or functions described in conjunction with FIG. 3 may be included in other components, placed in subcomponents, or distributed across multiple devices without departing from the spirit or scope of aspects of the subject matter described herein.

Turning to FIG. 3, the apparatus 305 may include a browser 340, predicting components 310, and a data store 345. The predicting components 310 may include a feature generator 312, a search engine querier 315, an online trainer 320, a predictor 325, an interaction monitor 330, and a query processor 335. Although in one embodiment, the predicting components 310 may reside on the apparatus 305, in other embodiments, one or more of these components may reside on other devices. For example, one or more of these components may be provided as services by one or more other devices. In this configuration, the apparatus 305 may cause the functions of these components to be performed by interacting with the services on the one or more other devices and providing pertinent information.

The query processor 335 is operable to receive a query to be sent to a search engine. For example, when a user enters a query in the browser 340, the query processor 335 may receive this query before or after the query is sent to the search engine. The query processor 335 may then provide the query to others of the predicting components 310.

The feature generator 312 operates similarly as the feature generator 210 described in conjunction with FIG. 2. The feature generator 312 is operable to derive features associated with the query. As described previously, these features may be derived from two or more result pages returned in response to the query, may be based directly from the query, and/or may be based on matching between the query and the result pages. Furthermore, additional information such as user interaction with the browser or any of the other features mentioned herein may be generated by the feature generator 312.

The search engine querier 315 is operable to provide a query to one or more search engines and to obtain result pages therefrom. The search engine querier 315 may send the query to the one or more search engines in the background so as to not delay or otherwise hinder a current search the user is performing. The result pages may be provided to the feature generator 312 to derive features to provide to the predictor 325.

The interaction monitor 330 is operable to obtain user interaction information related to the query and to provide the user interaction information to the feature generator 312 for deriving additional features for the predictor 325 to use to determine the best search engine to satisfy the query.

The online trainer 320 may modify a classifier associated with the predicting components 310 in conjunction with information obtained regarding queries submitted by a user using the browser 340. For example, as described previously, information regarding user interaction during a query may be captured by the interaction monitor 330. This information may be used to modify the classifier to obtain a better search engine for the particular user who is using the browser 340. The online trainer 320 may also examine results from queries, user preferences, and other information to further tune the classifier to a particular user's searching habits.

The data store 345 comprises any storage media capable of storing data useful for predicting a best search engine. The term data is to be read broadly to include anything that may be stored on a computer storage medium. Some examples of data include information, program code, program state, program data, rules, classifier information, other data, and the like. The data store 345 may comprise a file system, database, volatile memory such as RAM, other storage, some combination of the above, and the like and may be distributed across multiple devices. The data store 345 may be external or internal to the apparatus 305.

The predictor 325 comprises a component that is operable to use at least one or more of the features generated by the feature generator 312 together with a previously-created classifier to determine the best search engine to satisfy the query. The predictor 325 may use any of the techniques mentioned herein to predict the best search engine for a particular query.

The browser 340 comprises one or more software components that allow a user to access resources (e.g., search engines, Web pages) on a network (e.g., the Internet). In one embodiment, the browser 340 may include the predicting components 310 as a plug-in, for example.

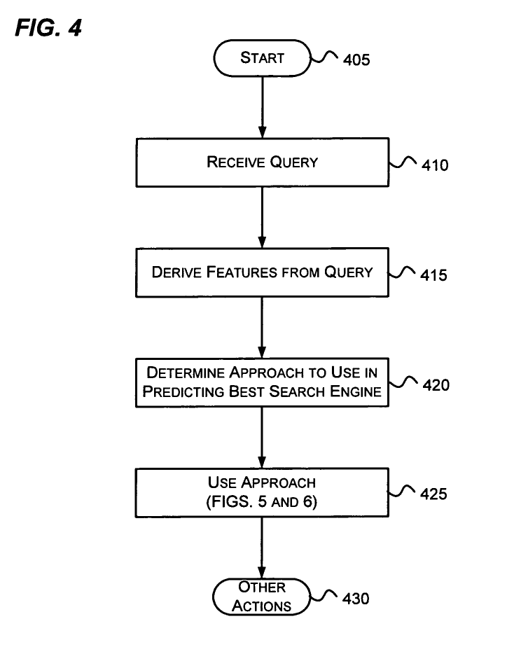

FIGS. 4-6 are flow diagrams that generally represent actions that may occur in predicting a best search engine in accordance with aspects of the subject matter described herein. For simplicity of explanation, the methodology described in conjunction with FIGS. 4-6 are depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. At block 410, a query is obtained. For example, referring to FIG. 3, the query processor 335 obtains a query from the browser 340.

At block 415, features of the query are derived. For example, referring to FIG. 3, the feature generator 312 derives features from the query obtained by the query processor 335.

At block 420, an approach to use in predicting the best search engine is determined. For example, referring to FIG. 3, the predicting components 310 may determine that just the query is to be used, that how well the query matches the results is to be used, that results from multiple search engines are to be used, or that another approach is to be used to estimate the best search engine.

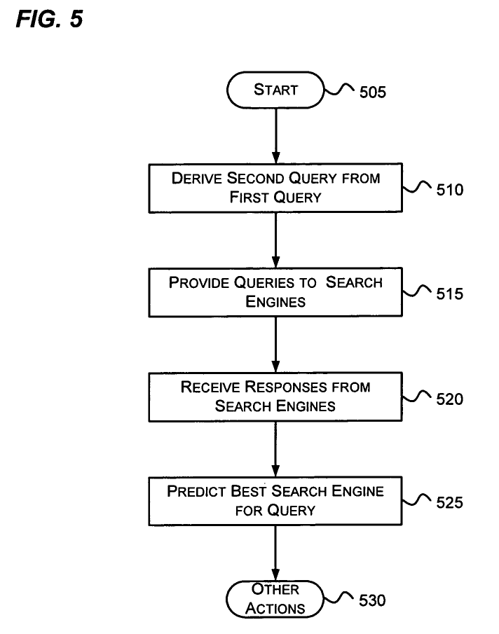

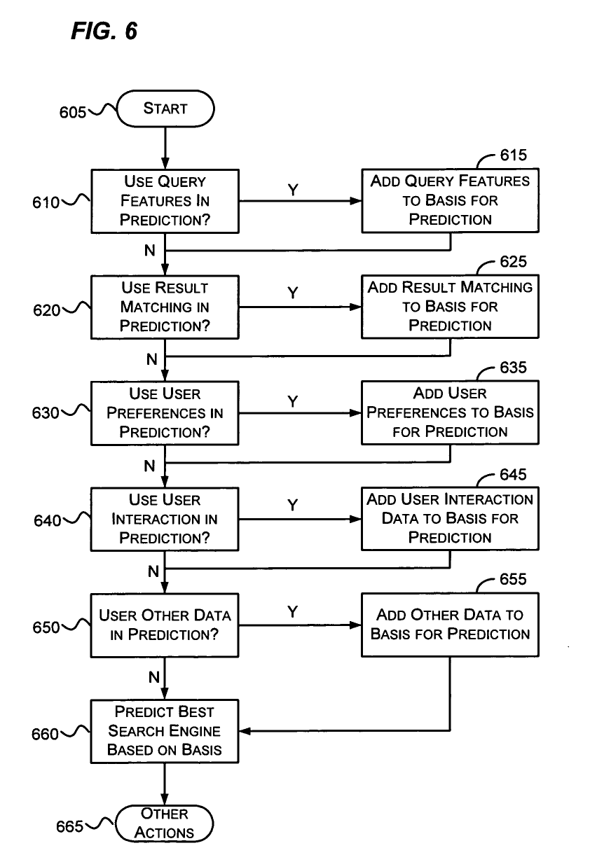

At block 425, the approach is used as described in more detail in conjunction with FIGS. 5 and 6.

At block 430, other actions, if any, are performed.

FIG. 5 is a flow diagram that generally represents exemplary actions that may occur when estimating the best search engine based on an approach where results of the various search engines are compared in accordance with aspects of the subject matter described herein. Turning to FIG. 5, at block 505, the actions begin. At block 510, a second query to submit to another search engine is derived from the query. The second query corresponds to the first query and is formatted appropriately for the other search engine. For example, referring to FIG. 1, the predicting components 130 receive a query for the search engine 120 and generate a query for the search engine 121. In addition, other queries may be derived from the query to submit to multiple search engines so that results from the multiple search engines may be compared to estimate a best search engine for the query.

At block 515, the queries are provided to the search engines. For example, referring to FIG. 1, the queries are provided to the search engines 120, 121 and 122.

At block 520, response that includes result sets are received from the search engines. For example, referring to FIG. 1, result sets from the search engines 120, 121, and 122 are received.

At block 525, the best search engine for the query is predicted. For example, referring to FIG. 3, the feature generator 312 generates features from the result sets received and provides these features to the predictor 325, which predicts the best search engine for the query.

At block 530, other actions, if any, are performed.

FIG. 6 is a flow diagram that generally represents exemplary actions that may occur when estimating the best search engine based on information other than results of various search engines in accordance with aspects of the subject matter described herein. The actions described in conjunction with FIG. 6 may be performed in many different ways without departing from the spirit or scope of aspects of the subject matter described herein. Indeed, there is no intention to limit the order of the actions to the order illustrated in FIG. 6. In one embodiment, the actions may occur in the order illustrated in FIG. 6. In other embodiments, however, the actions may be performed in parallel or in other orders than that illustrated in FIG. 6. For example, the actions associated with blocks 650 may occur before the actions associated with block 610. As another example, the actions associated with blocks 630 and 640 may be performed in parallel. In other embodiment, the actions of the blocks may be performed in any other orders and/or in parallel.

As another example, in one embodiment, instead of adding various factors to a basis that is later used for prediction, a predictor may receive all available information regarding a query and make a prediction based on that information. As another example, in another embodiment, a set of rules may determine what the predictor uses in making a prediction. Indeed, based on the teachings herein, those skilled in the art may recognize many different mechanisms for determining what to use in making a prediction of the best search engine without departing from the spirit or scope of aspects of the subject matter described herein.

Turning to FIG. 6, at block 605, the actions begin. At block 610, a determination is made as to whether to use query features in making a prediction. If so the actions continue at block 615; otherwise, the actions continue at block 615.

At block 615, query features are added to the basis for prediction. For example, referring to FIG. 3 the feature generator 312 may generate features from a query received by the query processor 335. In one embodiment, query features may always be used in making a prediction. In this embodiment, the actions associated with blocks 610 and 615 may be skipped.

At block 620, a determination is made as to whether to use result matching in making a prediction. If so, the actions continue at block 625; otherwise, the actions continue at block 630. At block 625, result matching information is added to the basis for prediction. For example, referring to FIG. 3, if matching information that indicates how well a query matches its results may be input into the predictor 325 (e.g., via the feature generator 312).

At block 630, a determination is made as to whether to use user preferences in making a prediction. If so, the actions continue at block 635; otherwise, the actions continue at block 640. At block 635, user preference information is added to the basis for prediction. For example, referring to FIG. 3, user preference information may be input into the predictor 325.

At block 640, a determination is made as to whether to use user interaction information in making a prediction. If so, the actions continue at block 645; otherwise, the actions continue at block 650. At block 645, user interaction data is added to the basis for prediction. For example, referring to FIG. 3, the interaction monitor 330 may provide user interaction data to the predictor 325.

At block 650, a determination is made as to whether to use other data in making a prediction. If so, the actions continue at block 655; otherwise, the actions continue at block 660. At block 655, the other data is added to the basis for prediction. For example, referring to FIG. 3 any other features may be provided to the predictor 325 for use in making a prediction.

At block 660, the best search engine is predicted based on the basis. For example, referring to FIG. 3, the predictor 325 makes a prediction of the best search engine to use for a particular query using determined features.

At block 665, other actions, if any, may be performed.

As can be seen from the foregoing detailed description, aspects have been described related to predicting a best search engine for a given query. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining a first query usable to obtain first results from a first search engine, the first search engine operable to provide the first results in response to receiving the first query;
providing one or more other queries to one or more other search engines, the one or more other queries corresponding to the first query such that the one or more other queries are derived from the first query and formatted appropriately for the one or more other search engines;
in response to providing the one or more other queries to the one or more other search engines, obtaining one or more other results from the one or more other search engines; and
predicting whether the one or more other results are better than the first results.

2. The method of claim 1, wherein predicting whether the one or more other results are better than the first results comprises using a classifier trained on features associated with different search engines.

3. The method of claim 2, wherein the classifier comprises a binary classifier.

4. The method of claim 2, wherein the classifier comprises a non-binary classifier.

5. The method of claim 2, wherein the features comprise user interaction with result sets returned from the different search engines.

6. The method of claim 2, wherein the features comprise estimated relevance of result sets returned from the different search engines.

7. The method of claim 2, wherein the features comprise diversity statistics of result sets returned from the different search engines.

8. The method of claim 2, wherein the features comprise metadata attributes of result sets returned from the different search engines.

9. The method of claim 2, wherein the features comprise titles, snippets, and resource locators associated with top-ranked documents of results sets returned from the different search engines.

10. A computer storage medium having computer-executable instructions, which when executed perform actions, comprising:
obtaining a query usable to obtain results from a first search engine; and
predicting a best search engine to use based at least in part on features of the query.

11. The computer storage medium of claim 10, wherein predicting a best search engine to use based at least in part on features of the query comprises predicting the best search engine based on a human language in which the query is represented.

12. The computer storage medium of claim 10, wherein predicting a best search engine to use based at least in part on features of the query comprises predicting the best search engine based on a frequency with which the query is submitted to search engines.

13. The computer storage medium of claim 10, wherein predicting a best search engine to use based at least in part on features of the query comprises performing a table lookup on a table that is created or updated during training a classifier, the table associating queries with search engines.

14. The computer storage medium of claim 10, wherein predicting a best search engine to use is also based on a degree to which a result page matches the query.

15. The computer storage medium of claim 14, wherein the degree comprises a frequency with which all or a portion of the query appears in a title, snippet, or result resource locator of a result set.

16. The computer storage medium of claim 10, wherein predicting a best search engine to use based at least in part on features of the query comprises using higher-order features associated with the query.

17. The computer storage medium of claim 10, wherein predicting a best search engine to use is also based on user preference.

18. In a computing environment, an apparatus, comprising:
a query processor operable to receive a query to be sent to a search engine;
a feature generator operable to derive features associated with the query, the features being derived from two or more result pages, based on the query, and/or based on matching between the query and the result pages; and
a predictor operable to use at least one or more of the features together with a previously-created classifier to predict a best search engine to satisfy the query.

19. The apparatus of claim 18, further comprising a search engine querier operable to provide the query to two or more search engines and to obtain the result pages therefrom.

20. The apparatus of claim 18, further comprising an interaction monitor operable to obtain user interaction information related to the query and to provide the user interaction information to the feature generator for deriving additional features for the predictor to use to determine the best search engine to satisfy the query.
